(19) United States
(12) Patent Application Publication
(10) Pub. No.: US 2026/0370099 A1
(43) Pub. Date: Nov. 19, 2026

(54) Lead Wire Clip, Motor Stator and Method for Restricting Lead Wires

(71) Applicant: Siemens Aktiengesellschaft, München (DE)

(72) Inventors: Hai Qiao Feng, Nanjing, JS (CN); An Bang Zheng, Nanjing, JS (CN); Chao Xu, Nanjing, JS (CN); Zuo Sheng Li, Nanjing, JS (CN); Jing Yu Zhang, Nanjing, JS (CN)

(73) Assignee: Siemens Aktiengesellschaft, München (DE)

(21) Appl. No.: 19/477,726

(22) PCT Filed: Apr. 24, 2023
(86) PCT No.: PCT/CN2023/090299

§ 371 Date: Oct. 22, 2025

(51) Int. Cl. H02K 11/33; H01R 12/53

(52) U.S. Cl. CPC H02K 11/33; H01R 12/53; H02K 2211/03

(57) ABSTRACT

Various embodiments include a lead wire clip. An example comprises: a restriction frame with a restriction hole to restrict lead wires connected to an object through the restriction hole; and a snap structure fixed on one side of the restriction frame and extending in a direction perpendicular to the restriction frame to clamp the object by matching with an opening on the object.

### CROSS-REFERENCE TO RELATED APPLICATIONS

This application is a U.S. National Stage Application of International Application No. PCT/CN2023/090299 filed Apr. 24, 2023, which designates the United States of America, the contents of which are hereby incorporated by reference in their entirety.

### TECHNICAL FIELD

The present disclosure relates to mechanical technologies. Various embodiments of the teachings herein include lead wire clips, motor stators, and method for restricting lead wires.

### BACKGROUND

For a motor stator, there is no any restriction on lead wires (for example, U, V, W three-phase power lead wires) of the motor stator before the motor stator is over molding, thus some bad circumstances may occur, for example, the lead wires are very close to the inner wall of the housing, and the lead wires are scattered and not upright. These bad circumstances may bring some problems to motor assembly.

At present, a heat-shrinkable tube or a nylon cable tie is usually adopted to restrict the lead wires, but the lead wires are just being concentrated, and the position of the lead wires are not controlled. Since the lead wires are close to the inner wall of the housing, sheath of the lead wires may be scratched by a motor cover when assembling the motor. Therefore, those skilled in the art are committed to finding solutions for restricting the lead wires of the motor stator.

### SUMMARY

Some example embodiments of the teachings herein include a lead wire clip, a motor stator, and a method for restricting lead wires are provided to restrict the lead wire. For example, some embodiments include a lead wire clip comprising: a restriction frame with a restriction hole, used to restrict lead wires connected to an object by making the lead wires pass through the restriction hole of the restriction frame; a snap structure, fixed on one side of the restriction frame and extending in a direction perpendicular to the restriction frame, and used to clamp the object by matching with an opening on the object.

As another example, some embodiments include an electronic device comprising: an object, comprising lead wires, and an opening located near the lead wires; and a lead wire clip as described herein.

As another example, some embodiments include a method for restricting lead wires of an electronic device comprising: passing the lead wires of the object of the electronic device through the restriction hole of the restriction frame of the lead wire clip; passing the snap structure of the lead wire clip through the opening of the object to enable the snap structure to clamp the object.

### BRIEF DESCRIPTION OF THE DRAWINGS

For a better understanding of the present disclosure, reference should be made to the Detailed Description below, in conjunction with the following drawings in which like reference numerals refer to corresponding parts throughout the figures.

FIGS. 1A and 1B are schematic diagrams illustrating a lead wire clip incorporating teachings of the present disclosure;

FIGS. 2A and 2B are schematic diagrams illustrating an object incorporating teachings of the present disclosure; and

FIGS. 3A to 3C are schematic diagrams illustrating the object in FIGS. 2A and 2B with the lead wire clip in FIGS. 1A and 1B.

The reference numerals are as follows:

| Reference numeral | Object |
|---|---|
| 1 | lead wire clip |
| 11 | restriction frame |
| 111 | restriction hole |
| 12 | snap structure |
| 121 | snap |
| 1211 | outer surface |
| 122 | guide post |
| 2 | object |
| 21 | opening |
| 22 | lead wire |
| 23 | bond pad |
| 41, 42 | processes |

### DETAILED DESCRIPTION

It can be seen from the above technical solutions, since a lead wire clip can be fixed on the object, for instance, a PCB, the lead wire of the object can be limited to a specific location by the restriction frame, thus restricting the lead wire is achieved. Since the lead wires can be limited to a specific location by the lead wire clip, being scratched by the motor cover can be avoided.

In addition, since the bond pads are changed to toward the non-drive end side, the welding reliability of the lead wire can be improved.

In order to restrict the lead wires of the motor stator, it is considered to provide a lead wire clip for the PCB, since the lead wires of the motor stator is connected to a printed circuit board (PCB), at the same time, it is considered to set a corresponding structure on the PCB for fixing the lead wire clip. Of course, the technical solutions can also be applied to other similar application scenarios.

Reference will now be made in detail to examples, which are illustrated in the accompanying drawings. In the following detailed description, numerous specific details are set forth in order to provide a thorough understanding of the present application. Also, the figures are illustrations of an example, in which assemblies shown in the figures are not necessarily essential for implementing the present application. In other instances, well-known assemblies, components, and circuits have not been described in detail so as not to unnecessarily obscure aspects of the examples.

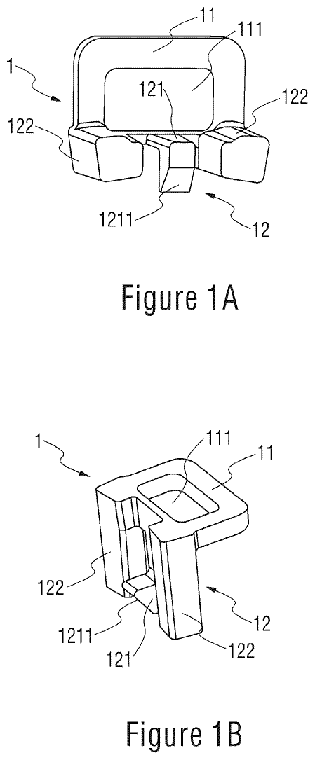

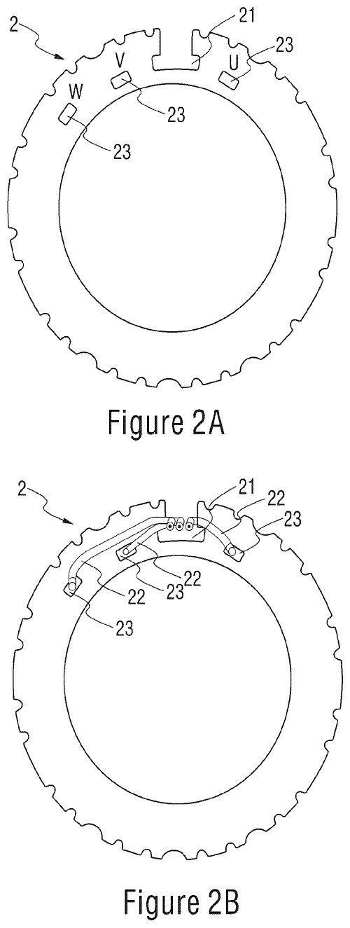

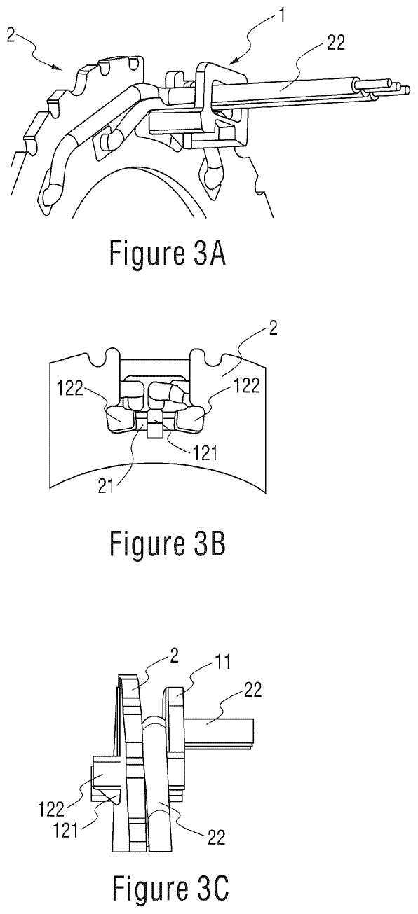

FIGS. 1A and 1B are schematic diagrams illustrating a lead wire clip incorporating teachings of the present disclosure. FIGS. 2A and 2B are schematic diagrams illustrating an object incorporating teachings of the present disclosure. FIGS. 3A to 3C are schematic diagrams illustrating the object in FIGS. 2A and 2B with the lead wire clip in FIGS. 1A and 1B.

As shown in FIGS. 1A to 3C, the lead wire clip 1 includes a restriction frame 11 with a restriction hole 111 and a snap structure 12, and the object 2 includes an opening 21 and lead wires 22. For a motor stator, the object may be a PCB, and the lead wires may be U, V, W three-phase power lead wires. In an example, the opening 21 is inverted T-shaped, in another example, the opening 21 may be rectangular. In addition, bond pads 23, for soldering the lead wires 22, on the PCB may be changed to toward non-drive end (NDE) side of the motor stator, namely the bond pads 23 may be changed from the back of the PCB to the front of the PCB, thus the soldering of the lead wires 22 is easy.

The restriction frame 11 is used to restrict lead wires 22 connected to an object 2 by making the lead wires 22 pass through the restriction hole 111 of the restriction frame 11. As shown in FIGS. 1A to 3C, in an example, the restriction hole 111 is rectangular. In other examples, the restriction hole 111 may have other shape, for instance, circular or triangular, and the like. The snap structure 12 is fixed on one side of the restriction frame 11 and extending in a direction perpendicular to the restriction frame 11, and is used to clamp the object 2 by matching with an opening 21 on the object 2.

In some embodiments, the snap structure 12 may include a snap 121 and two guide posts 122. The snap 121 is used to clamp the object 2. In an example, the snap 121 is in a shape of a hook, and the hook is flexible and a free end of the hook has an inclined outer surface 1211, thus it is easy for the snap structure 12 to pass through the opening 21.

The two guide posts 122 are located on both side of the snap 121, and are used to guide the snap 121 through the opening 21 and clamp the object 2 in a first direction, while the two guide posts 122 are restricted by the opening 21 in a second direction. The second direction is perpendicular to the first direction. Thus the position of the lead wire clip 1 is fixed.

Some embodiments an electronic device, which includes an object mentioned above and a lead wire clip a described herein. The electronic device may comprise a motor stator and the object may comprise a printed circuit board (PCB) of the motor stator.

In addition, some embodiments of the teachings herein include a method for restricting lead wires of an electronic device mentioned herein. The method may include the following processes.

Block 41, the lead wires 22 of the object 2 of the electronic device are passed through the restriction hole 111 of the restriction frame 11 of the lead wire clip 1.

Block 42, the snap structure 12 of the lead wire clip 1 is passed through the opening 21 of the object 2 to enable the snap structure 12 to clamp the object 2.

When the snap structure 12 is passed through the opening 21, the inclined outer surface 1211 of the snap 121 is compressed by the opening 21, and then the snap 121 is deformed. After being passed through the opening 21, the snap 121 returns to its original shape and clamps onto the object 2.

Since a lead wire clip can be fixed on the object, for instance, a PCB, the lead wire of the object can be limited to a specific location by the restriction frame, thus restricting the lead wire is achieved. Since the lead wires can be limited to a specific location by the lead wire clip, being scratched by the motor cover can be avoided, and the welding reliability of the lead wire can be improved. In addition, the assembly of the lead wire clip is easy and firm.

It should be understood that, as configured herein, unless the context clearly supports exceptions, the singular forms “a” (“a”, “an”, “the”) are intended to include the plural forms. It should also be understood that, “and/or” configured herein is intended to include any and all possible combinations of one or more of the associated listed items.

The example embodiments described herein are only presented to provide a concrete basis for the description, and do not represent any limits to the implementations. The foregoing description, for purpose of explanation, has been described with reference to specific examples. However, the illustrative discussions above are not intended to be exhaustive or to limit the present application to the precise forms disclosed. Many modifications and variations are possible in view of the above teachings. The examples were chosen and described in order to best explain the principles of the present application and its practical applications, to thereby enable others skilled in the art to best utilize the present application and various examples with various modifications as are suited to the particular use contemplated.

What is claimed is:

1. A lead wire clip comprising:
a restriction frame with a restriction hole to restrict lead wires connected to an object through the restriction hole; and
a snap structure fixed on one side of the restriction frame and extending in a direction perpendicular to the restriction frame to clamp the object by matching with an opening on the object.

2. The lead wire clip according to claim 1, wherein the snap structure comprises:
a snap, to clamp the object; and
two guide posts located on either side of the snap to guide the snap through the opening to clamp the object in a first direction;
wherein the two guide posts are restricted by the opening in a second direction perpendicular to the first direction.

3. The lead wire clip according to claim 1, wherein:
the snap comprises a hook; and
a free end of the hook has an inclined outer surface.

4. The lead wire clip according to claim 1, wherein the object comprises a printed circuit board (PCB) of a motor stator.

5. The lead wire clip according to claim 4, wherein the opening has a rectangular or inverted T-shaped.

6. An electronic device comprising:
an object including lead wires; and
an opening located near the lead wires; and
a lead wire clip comprising: a restriction frame with a restriction hole to restrict lead wires connected to an object through the restriction hole and a snap structure fixed on one side of the restriction frame and extending in a direction perpendicular to the restriction frame to clamp the object by matching with an opening on the object.

7. The electronic device according to claim 6, wherein:
the electronic device comprises a motor stator; and
the object comprises a printed circuit board (PCB) of the motor stator.

8. The electronic device according to claim 6, further comprising bond pads for soldering the lead wires located toward a non-drive end side of the motor stator.

9. The electronic device according to claim 7, wherein a shape of the opening is a rectangle or an inverted T-shaped.

10. A method for restricting lead wires of an electronic device, the method comprising:
passing lead wires of an object of the electronic device through a restriction hole of a restriction frame of a lead wire clip; and
passing a snap structure of lead wire clip through an opening of the object to enable the snap structure to clamp the object.
